(19) United States
(12) Patent Application Publication
(10) Pub. No.: US 2006/0053092 A1
(43) Pub. Date: Mar. 9, 2006

(54) Method and system to perform dynamic search over a network

(76) Inventors: Chris Foo, Santa Ana, CA (US); Yoon-Chok Chin, Richmond Hill (CA)

Correspondence Address: Chris Foo, P.O. Box 28151, Santa Ana, CA, 92799, US

(21) Appl. No.: 10/930,820

(22) Filed: Sep. 1, 2004

(51) Int. Cl. G06F 17/30; G06F 7/00

(52) U.S. Cl. 707/3

(57) ABSTRACT

This method and system is used to perform dynamic search over a network. This system was developed to extend the search context and improve the accuracy of search results. A search program retrieve an initial set of relevant information corresponds to a web site by matching a user's search conditions to an index database. A refines and dynamic search of a user's search conditions will be performed on the remote server upon selection of the initial set of retrieved component.

### BACKGROUND

Most search engines operate under the assumption that keywords and web sites will be indexed and stored in a centralized server. However, this assumption is not true. Often, any changes made to the web site will never get index for several months. In additional, centralized search engine store information in a centralized location where information is growing exponentially with more data being added to the database. Thus, most search engine companies are struggling to explore new method to retrieve the information effectively.

Therefore, a needed for methods and apparatus to resolve the overwhelm data stored in a centralized system as well as creating a dynamic and accurate search systems.

### DETAILED DESCRIPTION

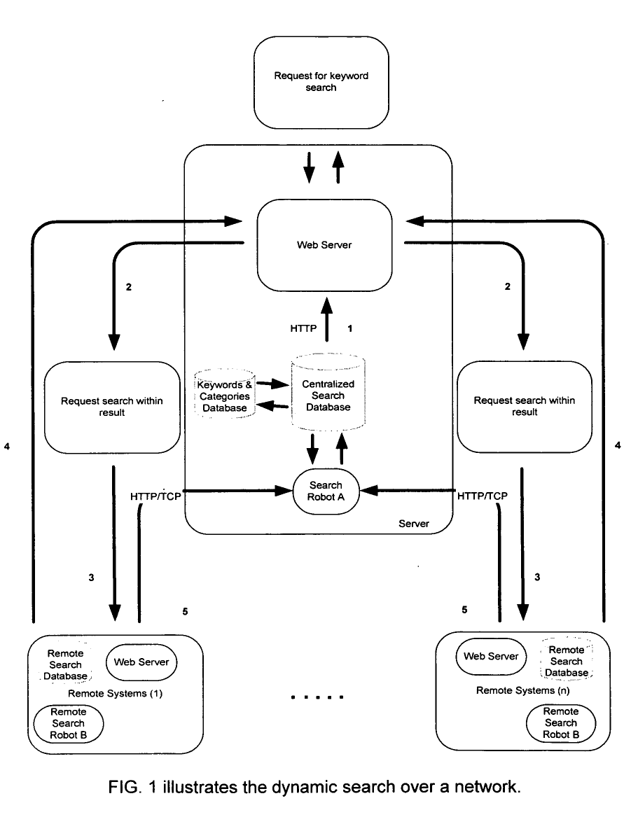

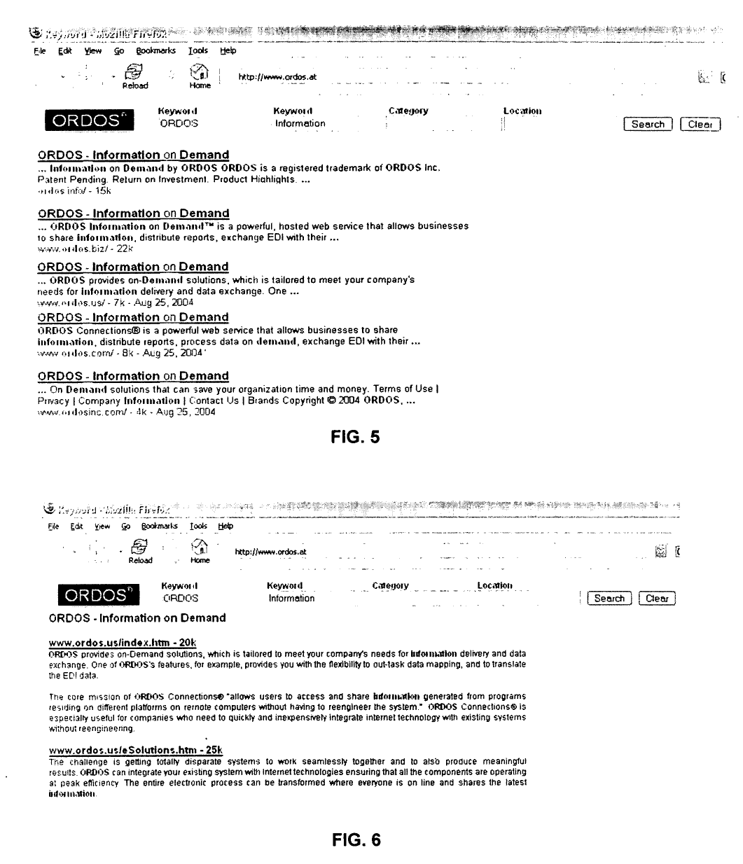

FIG. 1 illustrates the dynamic search over a network. 1 shows user request keyword search either from a web browser or a proprietary desktop application. The web server processed the initial search request and retrieved a list of matched domain addresses with unique description from the database (FIG. 5). 2 The description also consists of a hyperlinked correspond to the web site where dynamic search can be performed if the selection is clicked on. Before the searchable keyword is transmit to the remote web server for processing, the initial requested keyword will be displayed on the search panel. This allows users to make any changes on the searchable keywords before sending to the remote server. In addition to the searchable keywords, users also provided with options either to perform a remote dynamic search on the specific web site or on all others sites that hosted by the same web server. 3 The web server is a software program that will process all requests received and 4 retrieve all information stored in the remote database that matched the keywords. The retrieved information will be sorted and displayed according to its relevance of the search conditions (FIG. 6). 5 The web server, remote search database and all other required software programs can be resided in a computer, mobile devices, computer router or any devices that able to process computer program.

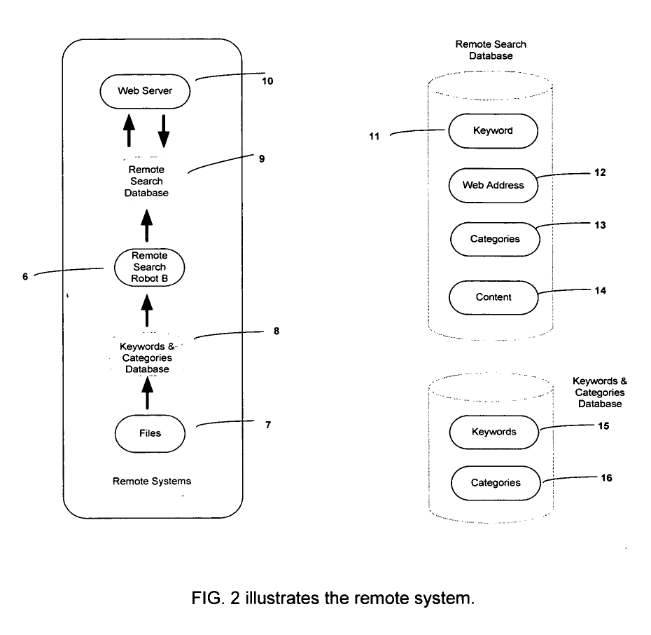

FIG. 2 illustrates the remote system. 6 The remote search robot is a software program that will retrieve part of the content from 7 files consisting keywords stored in the 8 keywords & categories database. The remote search robot is trigger either in real-time mode by user requesting a remote search or at scheduled intervals. The retrieved content will be stored in the 9 search database and retrieve whenever a match occurs. The web server 10 will process all received searchable keywords. The remote search database consists of four basic fields such as keyword 11, web address 12, categories 13, and content 14.

The keywords & categories database is updated by the remote search program regularly either by retrieving the latest keyword 15 and categories 16 lists from the server or manually updated by web site owner.

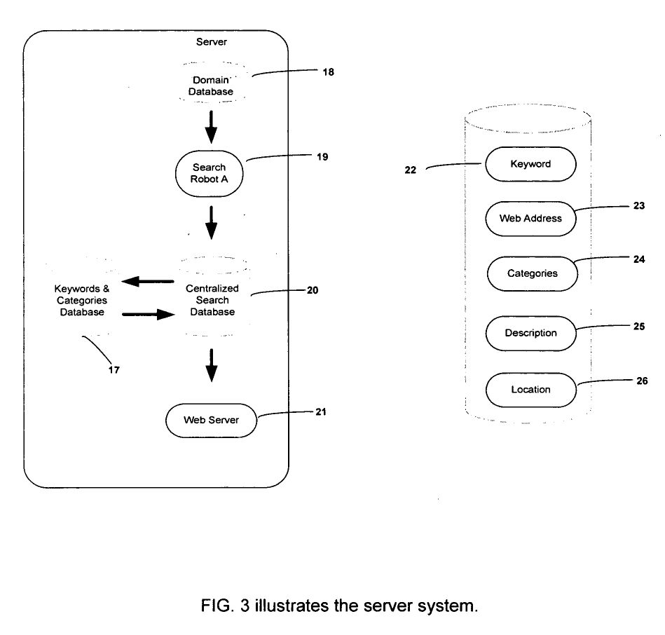

FIG. 3 illustrates the server system. The Keywords and Categories database 17 consists of unique keywords and categories used in performing searches. These keywords and categories either manually updated by Administrator or stored in the database when a search is requested by user.

The domain database 18 consists of unique domain addresses that routinely obtain from the internet by a search robot program 19 at scheduled intervals. The domain address stored in the database is the Uniform Resource Locator (URL) consists of only the protocol and the domain name where the resource is located.

For example, the http://www.ordos.com/index.html will be stored in the database 20 as http://www.ordos.com instead. Upon retrieve the index page, the Meta tag defined by the web page author such as keyword 22, web address 23, categories 24, description 25 and location 26 will be stored in the search database. This information will be retrieved as initial results if a match occurs.

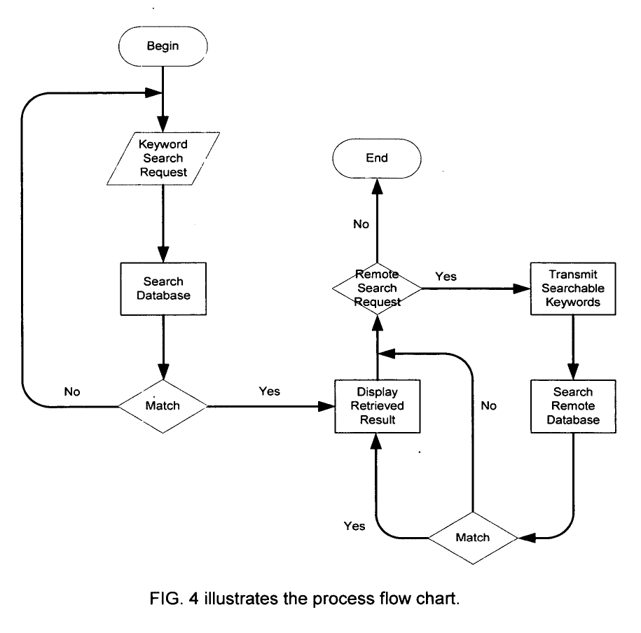

FIG. 4 illustrates the process flow chart. When a keyword search is requested, the system will determined if a match has occurs. If no record in the search database that match the requested keyword, a “No record found. Try different keyword.” message will be displayed requesting a more descriptive keyword. On the other hand, if records are found, it will then be retrieved and displayed online as shown in FIG. 5.

Based on the categories and brief description of the retrieved information, user will be able to determine what information is the most interests and relevant to the search. When user click on the desire site, all the content consists of the search keyword will be dynamically search and retrieve from remote database for viewing (FIG. 6).

### SUMMARY

Methods and apparatus consistent with the present invention, as embodied and broadly described herein, provide a decentralized dynamic search systems in response to the over burden centralized systems. In addition, web sites will no longer require waiting to be indexed in the centralized system. Consistent with the invention, a more descriptive and thorough search can easily be performed in a separate remote process.

What is claimed is:

1. A computer-implemented method for performing a dynamic search queries over a network. The method comprising: a process retrieving web site information over a network; an automate remote process matching and storing part of documents into a remote database; providing searchable keywords to a search program; generating a list of matched results from the database, where the results consist of hyperlinked to corresponding web pages and remote search program; forward searchable keywords to remote search program; retrieved refined search results from remote database.

2. The method of claim 1, wherein a process retrieving web site information comprises the steps of: seeking and filtering domain address; retrieving tags identifying the web pages; organizing and storing indexes into a database.

3. The method of claim 2, wherein seeking and filtering comprises retrieving domain address from the web pages and storing unique domain address or uniform resource locator (URL) in the domain database where the domain database only consists of unique domain address.

4. The method of claim 2, wherein the tags comprises keywords, web address, categories of the web page, description and location.

5. The method of claim 2, wherein organizing and storing indexes into a database comprises steps to eliminate duplicate and store tags record in the database.

6. The method of claim 1, wherein remote process can be triggered real-time or scheduled at predefined intervals.

7. The method of claim 1, wherein matching and storing part of documents into a remote database comprises the steps of: maintaining keywords and categories database; retrieving and storing content corresponds to the matched keywords.

8. The method of claim 7, wherein keywords and categories database comprises a set of common keywords and categories stored in the database.

9. The method of claim 7, wherein maintaining keywords and categories database comprising a process to manually or automatically update and delete records in the database.

10. The method of claim 9, wherein automatically update records in the database comprising a program at a scheduled intervals communicate with server retrieving the latest keywords and categories from server database.

11. The method of claim 7, wherein retrieving and storing content corresponds to the matched keyword comprises matching and retrieving content document consists of matched keyword and storing into the database.

12. The method of claim 1, wherein providing searchable keywords to a search program comprises the steps of: accepting searchable keywords; transmit searchable keywords to search program.

13. The method of claim 12, wherein searchable keywords consists of a list of at least one keyword and other conditions such as target web address, category, and location.

14. The method of claim 1, wherein generating a list of matched results from the database comprising matching and sorting the results based on relevance of the search conditions.

15. The method of claim 1, wherein forward searchable keywords to remote search program comprise steps of: accepting additional search conditions and keywords; encrypting searchable keywords; transmit searchable keywords to target search program.

16. The method of claim 15, wherein remote search program comprising a computer program that resides on a remote apparatus such as computer router, server or any mobile devices.

17. The method of claim 15, wherein accepting additional search conditions and keywords comprising appending additional user entered keywords to the initial search string.

18. The method of claim 15, wherein transmit searchable keywords to target search program further comprises the steps of: decrypting searchable keywords; performing keyword matching against stored information in the database.

19. The method of claim 1, wherein retrieved refined search results from remote database comprising sorting the results based on relevance of the search conditions.
